(19) United States
(12) Patent Application Publication
(10) Pub. No.: US 2018/0095163 A1
(43) Pub. Date: Apr. 5, 2018

(54) PHASE-MODULATED CONTINUOUS WAVE RADAR SYSTEM (WITH PRBS CODES)

(71) Applicants: John Lovberg, San Diego, CA (US); Vladimir Kolinko, San Diego, CA (US)

(72) Inventors: John Lovberg, San Diego, CA (US); Vladimir Kolinko, San Diego, CA (US)

(21) Appl. No.: 15/284,460

(22) Filed: Oct. 3, 2016

(51) Int. Cl. G01S 7/02; G01S 13/93; G01S 7/35

(52) U.S. Cl. CPC G01S 7/023; G01S 7/35; G01S 13/931

(57) ABSTRACT

A phase modulated continuous wave radar system comprising a radar control system utilizing a Pseudo Random Bit Sequence (PRBS) as a long modulation code with simultaneous autocorrelation and cross-correlation interference resistance. the transmitter is co-sited with the receiver, the receiver can be given prior knowledge of the specific transmitted code that it is correlating to. This prior knowledge, which is not accessible in general to bi-static systems such as GPS and cell phone technology, allows for increased randomization of cyclic code structures in monostatic radar systems.

### CROSS REFERENCE TO RELATED APPLICATIONS

This application represents a continuation of a provisional patent application entitled “PHASE-MODULATED CONTINUOUS WAVE RADAR SYSTEM” filed Sep. 23, 2015. (That application including its attachments is incorporated herein by reference.)

### FIELD OF THE INVENTION

The present invention relates to radar systems and in particular to phase modulated continuous wave radar systems.

### BACKGROUND OF THE INVENTION

### Frequency Modulated Continuous Wave Radar

Nearly all of the prior art in automotive radar describes frequency-modulated continuous wave radar architectures, in which a chirped frequency source is transmitted and the change in source frequency over the two-way time of flight to a reflecting object is measured to determine the range to that object.

### Phase Modulated Continuous Modulated Radar

Recently, an alternative to frequency modulated continuous wave radar, called phase modulated continuous wave radar (phase modulated CW radar), has been suggested as a potentially lower-cost approach for large-volume automotive radar applications. (Also, see IEEE Journal of Solid-State Circuits, Vol. 49, No. 12, December 2014; and IEEE Transaction on Circuits and Systems—I: Regular Papers, Vol. 61, No. 8 Aug. 2014. The phase modulated radar employs binary-phase-shift-keyed (BPSK) carrier modulation using engineered cyclic codes for signal transmission, coupled with pattern matching correlators in the radar receiver, as a means of determining precise time fiducials which measure two-way time of signal propagation out to and back from a reflective target. Compared with conventional frequency modulated radar, this approach eliminates the need for an expensive linear, broadband swept frequency source and high-performance digitizer in the radar front end, replacing these with low-cost code division multiple access (CDMA) inspired BPSK modulation and lower-performance digitizers. The efficacy of phase coding to discriminate a plurality of transmitters operating at the same carrier frequency has been proven over some decades in the deployment of GPS and cellular telephone technology. However, the extremely high dynamic range (>60 dB) in signal returns from a typical automotive radar far exceed the operating dynamic range of GPS or cell phone technology, and the orthogonality of known phase code sequences is inadequate to enable use of prior art phase modulated CW automotive radar by a large number of users in the same space without catastrophic interference. In short, the operating dynamic range enabled by known cyclic coding techniques is inadequate for general automotive radar applications.

### Pertinent Background Regarding Phase Modulation Code Systems

A common family of cyclic Pseudo-Noise (PN) codes used in GPS and CDMA systems, called Gold Codes, is named for Dr. Robert Gold, who invented the binary codes and methods for generating such codes in 1967. For such applications, the cyclic code is used to identify an individual transmitter, such as an individual GPS satellite or cell phone, and additional data may or may not be embedded within or between code cycles to carry information under the specific transmitter ID. Gold codes strike a balance between the need for: 1) a narrow, delta-function-like autocorrelation function and 2) a near-zero cross-correlation function; both ideal features for shared-spectrum uses such as cell phones, GPS and automotive radar.

It is well known that perfect (delta-function) autocorrelation and (zero) cross-correlation functions are not simultaneously achievable for cyclic pseudo-noise codes of finite length, but a special set of Gold codes has been defined for which the time-delayed autocorrelation and cross-correlation functions consist of only three bounded values. For a binary Gold code of length L=2ⁿ−1, these values, as normalized to an autocorrelation value of 1, are as follows:

$$- \frac{1}{L} , - \frac{{2}^{( n + k ) / 2} + 1}{L} , and \frac{{2}^{( n + k ) / 2} - 1}{L} ,$$

where k=1 for n odd and k=2 for n even but not divisible by 4 (this special set of codes does not exist for values of n divisible by 4). The shortcoming of these codes for radar applications is that the highest cross-correlation peaks are only down by ˜1/\sqrt{L} in amplitude (1/L in power) relative to the autocorrelation peak, limiting the useful dynamic range of an automotive radar to ˜35 dB for codes of practical length. Significantly longer codes require higher transmission rates and wider RF transmission bandwidth (currently inconsistent with FCC-allocated spectrum), or otherwise they limit the radar update rate and/or Doppler resolution to the point of being inadequate for increasing driver safety.

### What Is Needed

What is needed is a better method of phase coding.

### SUMMARY OF THE INVENTION

The present invention takes advantage of the fact that the radar transmitter and receiver is it the same location. Specifically, when the transmitter is co-sited with the receiver, the receiver can be given prior knowledge of the specific transmitted code that it is correlating to. This prior knowledge, which is not accessible in general to bi-static systems such as GPS and cell phone technology, allows for increased randomization of cyclic code structures in monostatic radar systems. Adding randomization in turn affords larger isolation from potentially interfering systems. This disclosure describes a method of randomizing cyclic codes to achieve a level of isolation that enables the effective use of low-cost randomized phase modulated CW radar architectures in automotive radar applications.

### BRIEF DESCRIPTION OF THE DRAWINGS

FIG. 1 is schematic drawing of a phase modulated continuous modulated radar.

FIGS. 2A and 2B illustrate an example of randomized code averaging.

### DETAILED DESCRIPTION OF PREFERRED EMBODIMENTS

The present invention makes use of Gold codes or other known preferred binary coding sequences, but rather than repeating a single code sequence in a cyclic fashion, a transmitted code is replaced by another near-orthogonal code (from the same family of sequences) after every cycle, in a random fashion. By virtue of this randomization, the position of code cross-correlation values at various code offsets changes from code to code, while the autocorrelation peak, at zero offset, is left unchanged. Thus by averaging the signal return over a large number of random Gold codes, the spectral power in the cross-correlation peaks spreads over a wide range of frequencies to a lower, more uniform background level while the magnitude of the autocorrelation peak remains unaffected. The result is that the ratio of the power in the autocorrelation peak relative to the highest cross-correlation false “echo” peaks is increased, thereby increasing the useful dynamic range of the automotive radar.

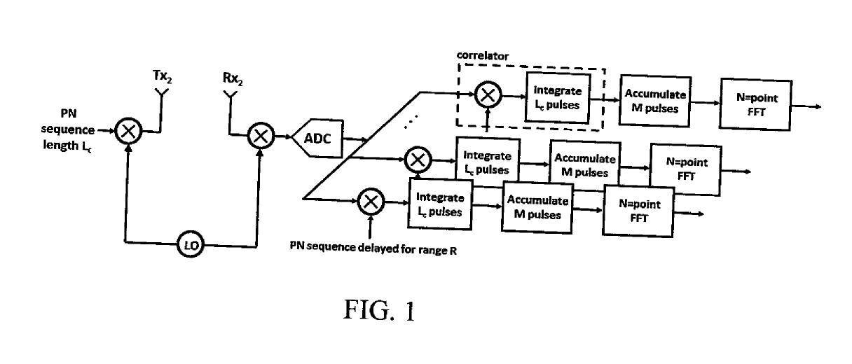

FIG. 1 is a basic schematic of prior art phase modulated CW radar, consisting of: Bi-phase modulation of transmit tone using pseudo-noise (PN) sequence, receiver baseband digitized (ADC) and demodulated using same PN sequence shifted to discriminate range bins, correlator to detect and integrate target signals in each range bin, accumulator to average signals over time, Fast Fourier Transform (FFT) to determine Doppler velocity of targets in each range bin. The schematic typically represents a single channel of a phased-array or multiple input—multiple output (MIMO) radar configuration.

As indicated in FIG. 1, after one or more (M) cycles of random Gold sequences, the output of the correlator generates a single point input to a Doppler Fast Fourier Transform (FFT) processor. When a large number (e.g. 1024) of such points has filled the processor buffer, an FFT is computed to determine the Doppler velocity of targets detected by the radar. By continual random selection of the Gold code sequences throughout the loading of the Doppler buffer, false target echoes are spread randomly over the FFT frequency spectrum, while true targets appear consistently at a single true Doppler frequency. This filtering effect adds another significant boost in useful radar dynamic range. The total useful dynamic range Γ is then the product of the original autocorrelation/cross-correlation ratio of the code of length L_{c}, cross-correlation function averaging factor, averaging factor over accumulator length M, and averaging factor over an N-point FFT:

$$Γ ( dB ) = 20 log ( \frac{{L}_{c}}{1 + 2 \sqrt{{L}_{c}}} ) + 20 log ( \frac{1 + 2 \sqrt{{L}_{c}}}{\sqrt{{L}_{c} + 1}} ) + 10 log M + 10 log ( \frac{N}{2} ) .$$

A typical repeated Gold sequence can support an operational dynamic range in radar return of 30 to 36 dB, depending upon sequence length (first term above); this is relative to a useful dynamic range of about 69 dB for radars dedicated to Long Range (typically 70 to 250 m), Medium Range (30 to 70 m), Short Range (10 to 30 m), or Ultra-Short Range (1 to 10 m) operation. Averaging over random binary sequences can add as much as 12 dB (for instance, for M=4) prior to Doppler processing (second and third terms above) and another 27 dB (for instance, for N=1024) in the FFT processor (fourth term above), increasing the radar's useful dynamic range to about 69 dB, as needed. However, the act of averaging false echo returns into the Fourier spectrum increases the noise floor of the FFT and thereby reduces the signal-to-noise ratio (SNR) of true targets.

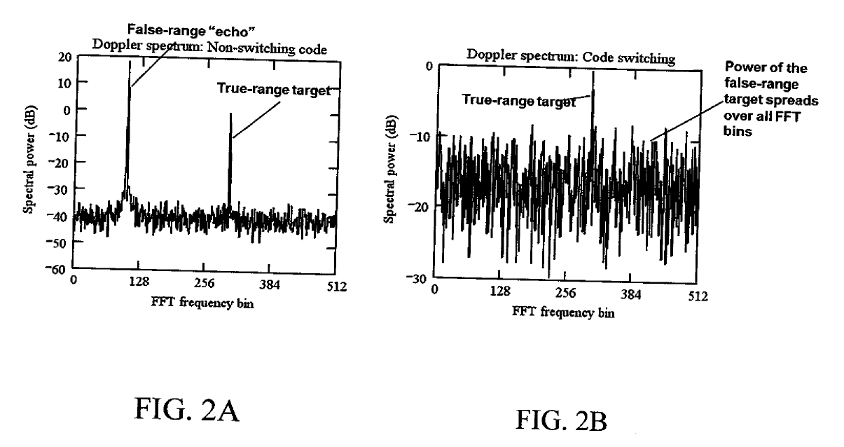

FIGS. 2A and 2B below illustrate an example of randomized code averaging. Given a weak target at a distant range in the presence of a very bright target at nearer range, a time-delayed cross-correlation peak from the larger target may generate false-target echo in the FFT processor at a level higher than the real return in the small target range bin (FIG. 2A), in a conventional radar processor using a single binary code repeated in a cyclic fashion. Under the same conditions, randomizing successive code cycles causes the false-target signal to spread uniformly into spectral noise in the FFT processor, but this also raises the FFT noise floor relative to the small target peak (FIG. 2B).

In multiple input-multiple output (MIMO) radar configurations, an array of correlators processes codes from a plurality of modulated transmitters across an array of receivers simultaneously. Signal targets within transmit-receive channel pairs using the same code are highly correlated, and thereby distinguished from the orthogonal signals in other MIMO channels. This allows for combining or otherwise processing signals independently for each transmitter across the receiver array, as long as the transmitter code sequences are mutually orthogonal (or nearly orthogonal). A MIMO array of n transmitters and m receivers can synthesize an array of m*n antenna elements across the sensing aperture; a spatial Fourier transform of this synthetic aperture provides digital beamforming to establish the angles of arrival of radar signals. False targets are smeared across the spatial field of regard of the radar (as their return signals combine non-constructively), while true targets are focused at a specific angular location. Performing this spatial FFT across all Doppler frequencies thereby adds a further significant factor to radar dynamic range. A cosine taper of an array of receivers will suppress targets at and beyond the first sidelobe of the antenna beam by more than 20 dB, thereby adding through beamforming the same amount of the false target suppression to the system dynamic range.

After final synthesis from a MIMO array, then, true targets rise further above the RMS noise level of the FFT generated by the false-range and off-angle bright targets, to increase the radar effective dynamic range to well over 70 dB.

### Pseudo-Random Binary Sequence Codes

A special family of codes that can be utilized for optimal spreading of cross-correlated PMCW radar signal returns is the so-called “Pseudo-Random Binary Sequence,” (PRBS) a binary data stream consisting of a random sequence of zeros and ones (or for BPSK modulation purposes a random sequence of positive and negative polarities), generated using linear shift registers and repeating after a specified sequence length. For PMCW radar application, the PRBS sequence is chosen to be much longer than the correlator/accumulator period, such that the cyclic nature of the code is irrelevant to the radar processor.

For purposes of consistency with discussion of randomized cyclic codes, the effective code length L_{c} for the PRBS code is 1 chip and the effective accumulator length M is arbitrary (but selected to enable Doppler processing at a desired velocity resolution and radar update rate). Using the general formula derived for randomized cyclic codes:

$$Γ ( dB ) = 20 log ( \frac{{L}_{c}}{1 + 2 \sqrt{{L}_{c}}} ) + 20 log ( \frac{1 + 2 \sqrt{{L}_{c}}}{\sqrt{{L}_{c} + 1}} ) + 10 log M + 10 log ( N ) \approx 10 log ( {L}_{c} MN ) .$$

Thus the total cross-correlation isolation provided (from the correlator and accumulator and through the N-point FFT processor) is given by the square root of the total number of chips sampled during the radar update period. This is consistent with the known RMS value of the sum of a number of negative and positive 1's in an equal probability distribution, and so holds true for the PRBS sequence as well as for randomized traditional cyclic codes. Small differences which arise from the Gaussian distribution of cross-correlation values of a PRBS sequence

As an example, we assume the use of a PRBS-31 code (i.e. 31 bits long), which repeats after 2,147,483,647 chips. We assume for purposes of discussion that the radar transmitter modulates its CW tone using this code at a chip rate of 1.58 Gcps. Considering each successive chip as a cyclic code of length L_{c}=1 and randomizing to a new code at the next chip interval, a sequence of (for instance) M=29,276 “code cycle” (chip) correlations are accumulated in approximately 18.5 microseconds, to generate a single time point in the FFT processor. After N=1024 points are loaded thus sequentially into the FFT buffer, the Doppler sampling period becomes L_{c}*M*N/1.58E9=18.97 milliseconds, corresponding to a Doppler frequency resolution of 0.100 m/s and a radar update rate of 52.7 Hz. After this radar frame is complete, successive values from the ongoing cycle of the PRBS-31 sequence continue to feed the correlator/accumulator/FFT processor for approximately 70.6 additional radar update periods before reaching its end. At this point the sequence begins repeating, at the center of a radar frame, and with no special significance to the wraparound point during the frame.

### Range Aliasing

Cyclic codes, such as repeated Gold code sequences, can create range aliasing in radar systems when the two-way time of flight of the transmitted signal reaches the code cycle duration. For instance, for a modulator operating at 1.58 Gcps and a code of length 2047 chips, the code repeats itself every 1.3 microseconds. This is the amount of time it takes for a signal to leave the radar transmitter, travel out to a reflecting target 195 meters away, and return to the radar receiver. As the code begins to repeat, a target further away from the radar than this 195 meter distance will auto-correlate at a point early in the sequence, looking identical to a target at 5 meters (200-195) from the radar due to the code “wraparound” in the correlator. The use of a very long random sequence such as PRBS31 eliminates range aliasing in the radar. The length of the PRBS31 code extends the ambiguous range out to over 200,000 kilometers, far beyond the operational range of the radar. The radar processor can still perform correlations on partial sequences from the longer PRBS31 code, in fact using sequences of arbitrary length. The longer the partial sequence used, the better the cross-correlation isolation for rejecting target echoes, with suppression going with the square root of the number of chips in the partial sequence. Unlike Gold codes and other common cyclic sequences, the length of a partial PRBS31 sequence is not constrained to specific values such as 2ⁿ−1 chips, a fact that is convenient in optimizing radar performance within given constraints on range, range resolution, Doppler resolution and update rate.

### Cyber Security

This method of increasing the autocorrelation-to-cross-correlation peak ratio is critical to unambiguously distinguishing weak signal returns, reflecting from small targets at longer radar ranges, against false range “echoes” resulting from cross-correlations of extremely bright targets at shorter ranges. An ancillary benefit of this method is that it provides a strong degree of cyber security—i.e. immunity to malicious efforts to overtake or disrupt control of a vehicle through spoofing of the receiver demodulator. The fact that the next code in the transmitted PN sequence is unknown to the radar transmitter itself makes it impossible to predict by a non-cooperative, intentional interferer.

### Target Tracking

In a highly populated and noisy target environment, false echo targets can be detected due to the pure randomness of the noise spikes in the resulting Doppler spectrum. These spikes can appear at any FFT frequency but are very unlikely to be found at the same frequency across successive radar update frames. In addition to the false target suppression as described above, then, the system may incorporate a short-term target persistence algorithm, which will confirm target presence over two or more detection cycles. Such an algorithm would allow for a certain variation in range of the target parameters consistent with feasible velocity envelopes and variations in signal reflection from different parts of a target. In the rare event that a false target appears above detection threshold in a single radar frame, the algorithm notes its disappearance in the successive frame and disregards it. This approach adds at least one frame of latency for automated functions such as emergency braking and adaptive cruise control, and so must be constrained to time delays consistent with functional radar requirements.

What is claimed is:

1. A phase modulated continuous wave radar system comprising a radar control system utilizing a Pseudo Random Bit Sequence (PRBS) as a long modulation code with simultaneous autocorrelation and cross-correlation interference resistance.
